(19) United States
(12) Patent Application Publication
(10) Pub. No.: US 2024/0325802 A1
(43) Pub. Date: Oct. 3, 2024

(54) SAFETY SYSTEM/DEVICE FOR AUTOMOBILE/VEHICLE

(71) Applicant: Kevin Yang, Fremont, CA (US)

(72) Inventor: Kevin Yang, Fremont, CA (US)

(73) Assignee: Kevin Yang, Fremont, CA (US)

(21) Appl. No.: 17/855,339

(22) Filed: Jun. 30, 2022

(51) Int. Cl. A62C 3/07; A62C 99/00

(52) U.S. Cl. CPC A62C 3/07; A62C 99/0045

(57) ABSTRACT

Disclosed is a device configured for placement in the trunk of a vehicle. Embodiments are used to provide a buffer for protecting the front trunk of a vehicle. The device includes fire retardant/extinguisher powder that releases in the event of a fire caused by collision. In embodiments, the device may consist of one or more layered structures of geometry shapes. The structure consists of vertical geometry cells for storing fire retardant extinguisher powders. Other accessories such as a top covering and handle may apply depending on the embodiments.

### RELATED APPLICATION

This application claims a benefit of a provisional patent application with the application No. 63/217,017 filed on Jun. 30, 2021 as the priority date.

### BACKGROUND

The embodiments herein relate generally to automobile safety, and particularly a safety system for automobiles with trunk(s) including front trunk(s) and/or rear trunk.

Motor vehicles with front trunks may lack rigidity and have very little shock absorption capabilities. Such vehicles may also be more prone to catching on fire upon collision. This may leave the driver and front-seat passenger vulnerable to serious injury. Therefore, an improved system for protecting front trunk and/or small vehicles and their drivers and passengers is needed.

### SUMMARY

Some embodiments of the present disclosure include a device configured for placement in the trunk of a vehicle that reinforces the trunk by significantly increasing its rigidity and providing a buffer for protection in the event of a collision. Additionally, the device may comprise a fire retardant/extinguisher powder, which is released upon impact, to inhibit fire that may result in the event of a collision. In embodiments, the device may have a geometrical shape that 1). fits within the trunk without creating an uneven weight distribution and 2). provides significant strength while still being very light and cost-effective.

In embodiments, the device may comprise multiple layers/panels, which may be coupled to one another by support beams. In some embodiments, the layers may have a hexagonal design. Additionally, each of the multiple layers may comprise cells/cubicles that store a safe amount of fire retardant/extinguisher powder that is sealed inside the cells. The fire retardant/extinguisher powder may be released in the event of a collision. In further embodiments, the device may optionally comprise a top cover and handle.

### BRIEF DESCRIPTION OF THE FIGURES

The detailed description of some embodiments of the invention is made below with reference to the accompanying figures, wherein like numerals represent corresponding parts of the figures.

FIG. 1 provides a view of the invention, according to certain embodiments.

FIG. 2 shows an exploded view of the invention, according to certain embodiments.

FIG. 3 shows the invention in use, according to certain embodiments.

FIG. 4 shows a product view of the invention, according to certain embodiments.

FIG. 5 shows a cutaway view of the invention, according to certain embodiments.

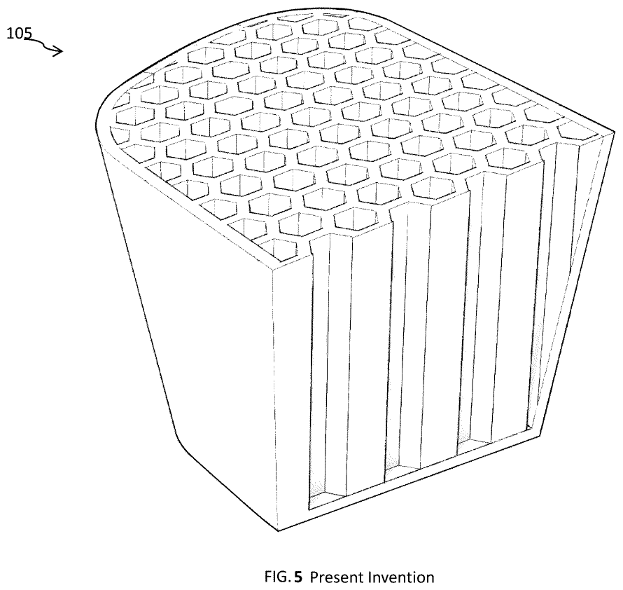

FIG. 6 shows the invention in use, according to certain embodiments.

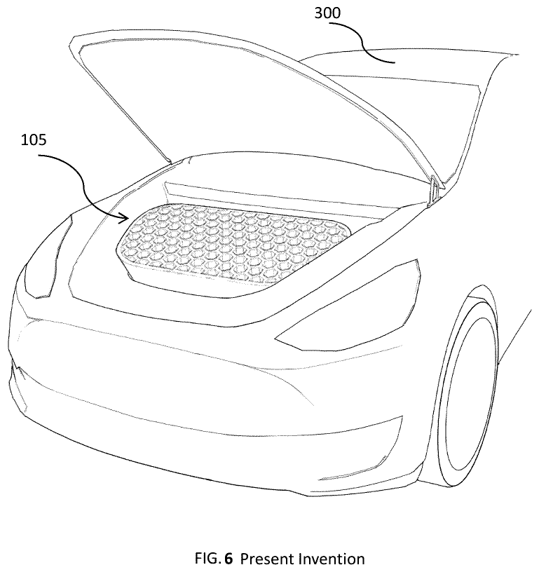

### DETAILED DESCRIPTION OF CERTAIN EMBODIMENTS

In the following detailed description of the invention, numerous details, examples, and embodiments of the invention are described. However, it will be clear and apparent to one skilled in the art that the invention is not limited to the embodiments set forth and that the invention can be adapted for any of several applications.

Vehicles having a front trunk, particularly small vehicles such as electric cars, may be particularly susceptible to damage and may even catch on fire during a collision. This may render the driver and front-seat passenger vulnerable to serious injury. While some approaches for enhancing safety for such vehicles have focused on strengthening the car chassis or frame, these approaches fail to address the front trunk, which typically may absorb the brunt of the impact during a front-end collision.

The disclosed subject matter provides a vehicle safety system for a front trunk vehicle that comprises placing a high shock absorbing and fire retardant/extinguisher device in the front trunk of the vehicle. In embodiments, the device provides maximum support for the front trunk while maintaining a high level of shock absorption with fire protection.

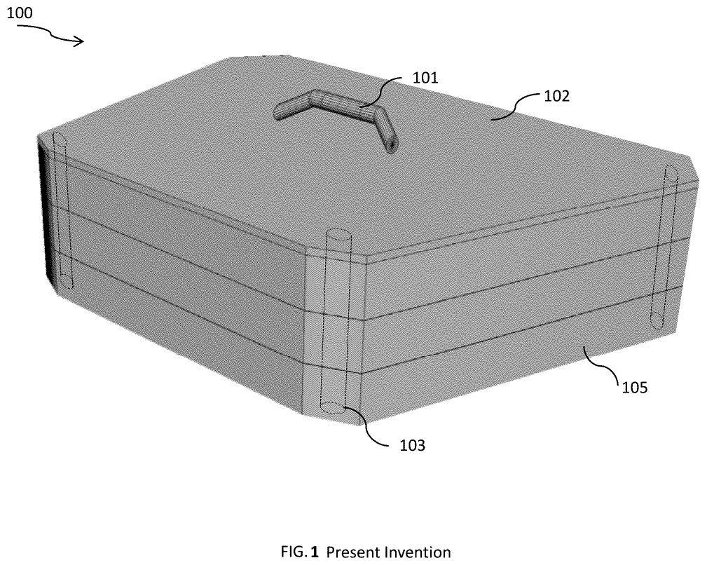

In embodiment (100), as depicted in FIG. 1, the disclosed device may comprise multiple layers (105), which may be coupled to one another by support beams (103). The dashed lines show the support beams (103) embedded inside the structure. In further embodiments, the device may optionally comprise a covering (102). In further embodiments, the device may optionally comprise a handle (101).

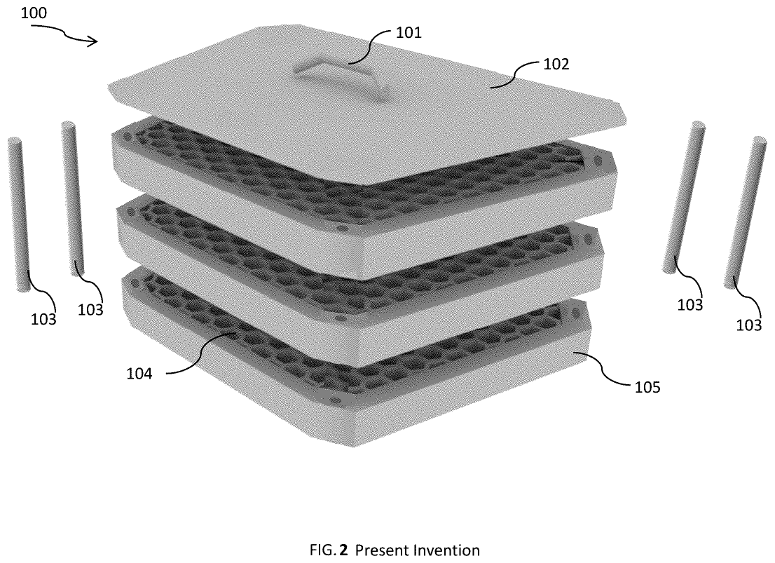

FIG. 2 presents an exploded view of the device. In this embodiment (100), four support beams (103) are shown on the side. Each of the multiple layers (105) may comprise cells (104) that store fire retardant/extinguisher powder that is sealed off inside the cells. The fire retardant/extinguisher powder may be released in the event of a collision. The cells (104) containing fire retardant/extinguisher powder are divided by the multilayer structure. Each cell's length is no longer than the length of the layer in this embodiment.

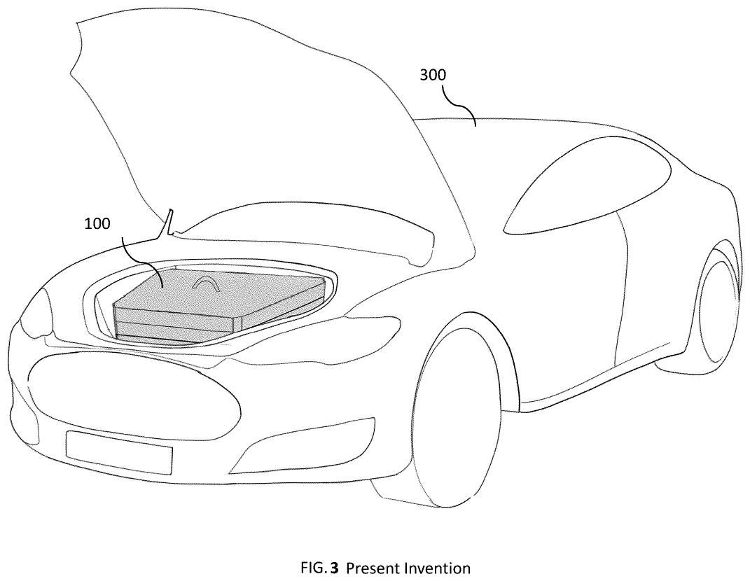

In certain embodiment, the placement in the front trunk of the vehicle is demonstrated in FIG. 3. Referring to FIG. 3, the device fits in the front trunk of the car (300), slightly lower than the height of the front trunk with the handle (101) does not hinder the closure of the front trunk.

In certain embodiments, the device may include 3 layers of hexagonal cells storing extinguisher powder and 4 support beams extending through the layers (and cover if used), as shown in the figure. Additionally, the device may be shaped and sized to fit within a front trunk of a vehicle, without creating an uneven weight distribution. In embodiments, the support beams may preferably extend through the layers, at around the corners of the layers to add extra support. The support beams may be, for example, made of metal, about 7 inches to about 9 inches in length (to fit in the front trunk). It should be understood, however, that the number of layers, support beams, materials, and geometric shape of the device is not limited to the embodiment shown. The device may include any number of layers and support beams, which may be arranged or structured in a variety of different configurations according to alternate embodiments. Additionally, the coupling mechanism is not limited to support beams. Other mechanisms such as latches may also be used depending on the embodiments.

In certain embodiments, the cells may be constructed out of carbon fiber materials and may be about 2 inches to about 2.5 inches tall. But the material and size of the cells are not limited to these options. Additionally, the cells are preferably hexagonal, but other geometric configurations, such as circular, triangular, etc., may also be used.

In some embodiments, the device may be provided with a covering (102), and a handle (101), may be attached to the covering to facilitate a user in carrying the device. In further embodiments, the covering and handle may be removable for easy access to the layers of structure. The covering and handle may be made from materials such as metal, carbon fiber, and the like, or a combination of materials, according to various embodiments. These components may have a thickness of about ½ of an inch, or about 3/16 of an inch, but are not limited to these options.

The device of the present invention is configured to fit snuggly into the front trunk of a vehicle, without sticking out or obstructing the car hood, and provides a protective structure for the front of the vehicle. Once placed inside the front trunk, it actively supports the trunk, so in the event of a front-end collision, it will act as a buffer and shock absorber. Additionally, it will release extinguisher powder that can snuff out most flames that may ignite in the front trunk area.

According to an exemplary embodiment, the invention may be made by separately molding the layers from carbon fiber, then inserting metal support beams through the layers. Each hexagonal layer may be filled up with extinguisher powder and sealed up before assembly.

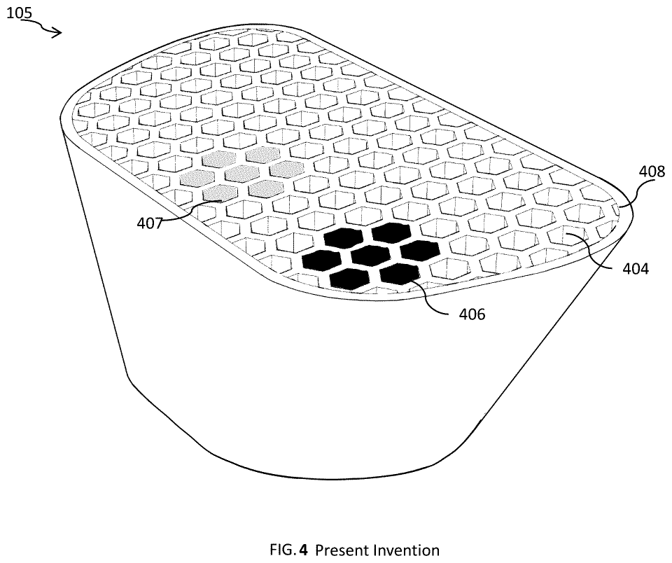

Referring to FIG. 4, the product view of certain embodiments, this embodiment (105) has a congruent structure. It is one layered structure, a variation of certain embodiments. The handle (101), covering (102), support beams (103), and multiple layers (105) may be absent, as shown. The cells (404) may extend vertically for fire retardant/extinguisher powder storage. Other variations may also be possible. An outside wall (408) is in place supporting the cell structures.

In certain embodiments, the fire retardant/extinguisher powder may be ABC dry chemical fire extinguisher powder (406), which mainly consists of Monoammonium Phosphate (NH4H₂PO₄) and Ammonium Sulfate ((NH₄)₂SO₄). But the choice of fire retardant/extinguisher power is not limited to these options. Other fire retardants/extinguisher powder, such as class D fire extinguisher power, which may consist of granular sodium chloride, may also be used.

In certain embodiments, each cell is sealed with a cover (407) to keep the fire retardant/extinguisher powder in place. The material used for the cover may be the same as the material for the cells, but other options may also apply.

While the invention is primarily designed for the front trunk, it may also be placed in the back trunk, according to alternate embodiments. Additionally, the device may be customized to fit the trunk of a specific vehicle, according to the specific shape and size of the trunk.

It should be understood that the disclosed constituent elements is intended to be exemplary only, and it is not intended that this list be used to limit the device of the present application to just these elements. Persons having ordinary skill in the art relevant to the present disclosure may understand there to be equivalent elements that may be substituted within the present disclosure without changing the essential function or operation of the device.

Persons of ordinary skill in the art may appreciate that numerous design configurations may be possible to enjoy the functional benefits of the inventive systems. Thus, given the wide variety of configurations and arrangements of embodiments of the present invention, the scope of the invention is reflected by the breadth of the claims below rather than narrowed by the embodiments described above.

1. An automobile safety device comprising one or more layer(s)/panel(s) of a structure configured as a whole device to snuggly fill into a trunk of the automobile for rigidity enhancement, shock absorption enhancement, and protection enhancement in case of a collision event.

2. The automobile safety device of claim 1 wherein each layer of the structure comprises an array of cell(s)/cubicle(s) wherein the cell comprises a hollow structure.

3. The automobile safety device of claim 2 wherein the hollow structure is filled with a safe amount of fire retardant/extinguisher powder sealed inside the cell and configured to be released from the cell in case of the collision event.

4. The automobile safety device of claim 1 wherein fire retardant/extinguisher powder comprises one or more of the following materials: ABC dry chemical fire extinguisher powder, comprising Monoammonium Phosphate (NH₄H₂PO₄) and Ammonium Sulfate ((NH₄)₂SO₄), and class D fire extinguisher power comprising granular sodium chloride.

5. The automobile safety device of claim 1 wherein in case more than one layer of the structure are snuggly filled into the front trunk of the automobile, the automobile safety device comprises a mechanism for coupling all needed layers of the structure together as the whole device for rigidity enhancement, shock absorption, and protection enhancement in case of a collision event.

6. The automobile safety device of claim 5 wherein the mechanism for coupling all needed layers of the structure together comprises one or more support beam(s) extending through the layers of the structure and coupling the layers of the structure to form the whole device.

7. The automobile safety device of claim 5 wherein the mechanism for coupling all needed layers of the structure together further comprises one or more latch(s) coupling the layers of the structure to form the whole device.

8. The automobile safety device of claim 1 wherein the structure comprises one or more of the following materials: carbon fiber, metal, metal alloy, composite material, and engineering plastic.

9. The automobile safety device of claim 1 wherein the automobile safety device further comprises a covering mechanism configured securely coupled atop the layer(s) of the structure and still ensured to snuggly filled in the front trunk.

10. The automobile safety device of claim 9 wherein the covering mechanism configured securely coupled atop the layer(s) of the structure comprises a handle for the automobile safety device easily to be lifted by a user.

11. The automobile safety device of claim 9 wherein the mechanism configured securely coupled atop the layer(s) of the structure comprises one or more of the following materials: carbon fiber, metal, metal alloy, composite material, and engineering plastic.

12. The automobile safety device of claim 2 wherein the cell comprises a hollow structure shaped with one or more of the following shape(s): hexagon, ball, triangle, and freedom/random.

13. The automobile safety device of claim 3 wherein the cell further comprises a hollow structure for being filled with the fire retardant/extinguisher power.

14. The automobile safety device of claim 13 wherein the trunk comprises one of a front trunk at a front portion of the automobile and/or a rear trunk at a rear portion of the automobile.

15. The automobile safety device of claim 2 wherein the cell has a dimension of height, width, or diameter around 2-2.5 inches.

16. The automobile safety device of claim 9 wherein the covering mechanism has a thickness around a half inch.

17. The automobile safety device of claim 10 wherein the handle has a thickness around a half inch.
